(19) United States
(12) Patent Application Publication
(10) Pub. No.: US 2009/0033619 A1
(43) Pub. Date: Feb. 5, 2009

(54) METHOD AND APPARATUS FOR CONTROLLING UNIVERSAL PLUG AND PLAY DEVICE TO REPRODUCE CONTENT IN A PLURALITY OF REPRODUCTION REGIONS ON SCREEN THEREOF

(75) Inventor: Seung-jae OH, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/031,251

(22) Filed: Feb. 14, 2008

(30) Foreign Application Priority Data
Jul. 31, 2007 (KR) 10-2007-0077167

(51) Int. Cl. G09G 5/00

(52) U.S. Cl. 345/156

(57) ABSTRACT

Provided are a method of reproducing content using a universal plug and play (UPnP) device which has a plurality of reproduction regions. According to the method, information regarding reproduction regions is obtained using newly defined actions before a control point calls an action “Play( ).” Then, a reproduction region for a piece of content is designated according to a user's input. Accordingly, the user can simultaneously enjoy a plurality of pieces of content in desired reproduction regions on a screen of a UPnP device.

### CROSS-REFERENCE TO RELATED APPLICATION

This application claims priority from Korean Patent Application No. 10-2007-0077167, filed on Jul. 31, 2007 in the Korean Intellectual Property Office, the disclosure of which is incorporated herein in its entirety by reference.

### BACKGROUND OF THE INVENTION

1. Field of the Invention

Methods and apparatuses consistent with the present invention relate to a universal plug and play (UPnP) network, and more particularly, to controlling a UPnP device which supports a plurality of reproduction regions, to reproduce content in the reproduction regions.

2. Description of the Related Art

FIG. 1A is a diagram for explaining a related art principle of reproducing audio/video (AV) content in a universal plug and play (UPnP) network. Referring to FIG. 1A, the UPnP network generally includes an AV Device 1, which functions as a source of content, another AV Device 2, which functions as a sink, and an AV control point which controls the AV devices.

In a UPnP AV specification, the AV device that functions as a source of content is a UPnP media server, and the AV device that functions as a sink is a UPnP media renderer. A media server stores various image, audio and video files. Examples of the media server include a personal computer, a set top box, a digital versatile disc (DVD) player, an MP3 player and a digital still camera (DSC), all of which have a hard disk drive (HDD), a flash memory and a DVD/compact disc (CD). Other examples of the media server may include a digital television (DTV), HiFi audio, and a monitor.

The UPnP media server extracts metadata of content, forms and manages a list of metadata in a DIDL-Lite format, and provides the list to an AV control point controlling UPnP AV devices. The UPnP media server provides a content director service (CDS) for browsing a list of contents, a connection manager service (CMS) for managing connection of UPnP devices, and an AVTransport (AVT) service for performing control operations related to content reproduction. The services are defined in the form of UPnP actions and called by the AV control point.

The UPnP media renderer reproduces content and, like the UPnP media server, provides the CMS and AVT services and a rendering control service (RCS) related to device setting (such as brightness and volume).

FIG. 1B is a flowchart illustrating a related art process of reproducing content at media renderer in a UPnP network.

Referring to FIG. 1B, a control point callinvokes an action “CDS::Browse/Search( )” provided by a UPnP media server and obtains a list of media contents that can be reproduced. If a user selects desired content through a user interface, the control point receives information regarding a transport protocol and a data format through the action “CM::GetProtocolInfo( )” of the media renderer and determines whether the selected content can be reproduced.

If it is determined that the selected content can be reproduced, the control point obtains an AVTransport identifier (ID), which is required to control connection, from the media server through an action “CM::PrepareForConnection( ).” In addition, the control point calls the action “CM::PrepareForConnection( )” of the media renderer and obtains AVTransportID and RCSInstanceID. In this case, RCSInstanceID is used to control, for example, volume, color and brightness of a reproducer.

In order to reproduce the selected content, the control point calls an action “SetAVTransportURI( )” of the media server or the media renderer. Here, a resource uniform resource identifier (URI) of the content to be reproduced is delivered as argument.

When the user presses a reproduction button, the control point calls an action “Play( )” of the media server or the media renderer whose action “SetAVTransportURI( )” has been called. If the control point calls the action “Play( )” of the media renderer, the media renderer requests the media server to transmit a file which corresponds to a URI received through the action “SetAVTransportURI( ).”

If the control points calls the action “Play( )” of the media server, the media server transmits a file, which corresponds to a URI set using the action “SetAVTransportURI( ),” to the media renderer. In this case, protocols, such as a hypertext transfer protocol (HTTP), a real-time transport protocol (RTP) and Institute of Electrical and Electronics Engineers (IEEE) 1394, may be used in order to stream actual content data. In the process of streaming content, various actions for playback control, such as Seek( ), Stop( ) and Pause( ), may be called. In addition, various actions defined in the RCS of the media renderer may be called in order to control, for example, volume, color and brightness of the reproducer.

After the selected content is reproduced, the control point calls an action “TransferComplete( )” in order to inform the media server and the media renderer that the selected content has been reproduced. When the action “TransferComplete( )” is called, the media server and the media renderer withdraw resources allocated to the above connection.

FIG. 2 illustrates a related art process of reproducing a plurality of pieces of content received from a media renderer. As described above, a control point calls an action “PrepareForConnection( )” of a media renderer. In this case, when there is only a single piece of content, an RCS instance identifier (RCS ID) has a value of zero.

In the related art UPnP AV specification, when the media renderer reproduces a plurality of pieces of AV content, each AV content stream is controlled using a virtual RCS ID. Each AV content stream has an RCS ID which has a positive value, not zero. The media renderer reproduces content streams in a Post-Mix form in which the content streams are combined, and the control point controls each stream using a virtual RCS ID whose value is not zero. The post-mix stream is set to RCS=0 and controlled accordingly.

The virtual RCS ID enables a reproduction related control operation to be performed on each stream. However, there is no method of controlling a media renderer to designate one of a plurality of rendering screens, for example, a main screen and an inset window in picture in picture (PIP) mode and reproduce each stream on the designated screen or window. If a user desires to control the media renderer to reproduce content in a desired reproduction region, the control point should be aware of screen information of the media renderer in advance. In addition, the control point should be able to control the media renderer to reproduce a stream received from the media server on a particular screen. However, it is impossible at present for the control point to control the media renderer in such a manner.

### SUMMARY OF THE INVENTION

The present invention provides a method of controlling a UPnP media renderer to reproduce content in one of a plurality of reproduction regions thereof using a control point.

According to an aspect of the present invention, there is provided a method of controlling a UPnP device, which has a plurality of reproduction regions on a screen thereof, using a remote control point. The method includes receiving information regarding the reproduction regions from the UPnP device; selecting one of the reproduction regions according to a user's input; and requesting the UPnP device to reproduce content in the selected reproduction region.

The method may further include requesting information regarding the reproduction regions by calling a predetermined action of a rendering control service (RCS) provided by a media renderer of the UPnP device.

The information regarding the reproduction regions may include an extensible markup language (XML) document which includes descriptive text of the reproduction regions and respective reproduction region IDs of the reproduction regions.

The requesting may include transmitting a message for informing the media renderer of the UPnP device about the selected reproduction region, wherein the message is used to call the predetermined action of the RCS provided by the media renderer of the UPnP device and includes a reproduction region ID of the selected reproduction region and an RCS instance ID for reproduction of the content.

According to another aspect of the present invention, there is provided a recording medium on which a computer program for executing the method is recorded.

According to another aspect of the present invention, there is provided a control point remotely controlling a UPnP device, which has a plurality of reproduction regions on a screen thereof The control point includes a reproduction region information reception unit receiving information regarding the reproduction regions from the UPnP device; a selection unit selecting one of the reproduction regions according to a user's input; and a reproduction request unit requesting the UPnP device to reproduce content in the selected reproduction region.

According to another aspect of the present invention, there is provided a method of reproducing content using a UPnP device, which has a plurality of reproduction regions on a screen thereof The method includes transmitting information regarding the reproduction regions to a remote control point; receiving, from the control point, a request to reproduce content in one of the reproduction regions designated by the control point; and reproducing the content in the designated reproduction region.

The method may further include receiving a message for requesting the information regarding the reproduction regions from the control point, wherein the message is used to call a predetermined action of an RCS provided by a media renderer of the UPnP device.

The information regarding the reproduction regions comprises an XML document which includes descriptive text of the reproduction regions and respective reproduction region IDs of the reproduction regions.

The receiving of the request may include receiving, from the control point, a message for calling the predetermined action of the RCS provided by the media renderer of the UPnP device, wherein the message includes a reproduction region ID of the designated reproduction region and an RCS instance ID for reproduction of the content.

According to another aspect of the present invention, there is provided a recording medium on which a computer program for executing the method is recorded.

According to another aspect of the present invention, there is provided a UPnP device having a plurality of reproduction regions on a screen thereof The device includes a reproduction region information transmission unit transmitting information regarding the reproduction regions to a remote control point; a reproduction request reception unit receiving, from the control point, a request to reproduce content in one of the reproduction regions designated by the control point; and a content reproduction unit reproducing the content in a designated reproduction region.

### BRIEF DESCRIPTION OF THE DRAWINGS

The above and other aspects of the present invention will become more apparent by describing in detail exemplary embodiments thereof with reference to the attached drawings in which:

FIGS. 1A and 1B are diagrams for explaining a related art method of reproducing a plurality of pieces of content in a universal plug and play (UPnP) network;

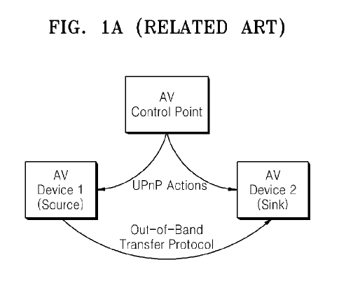

FIG. 2 is a diagram for explaining a related art method of reproducing a plurality of pieces of content using a UPnP device;

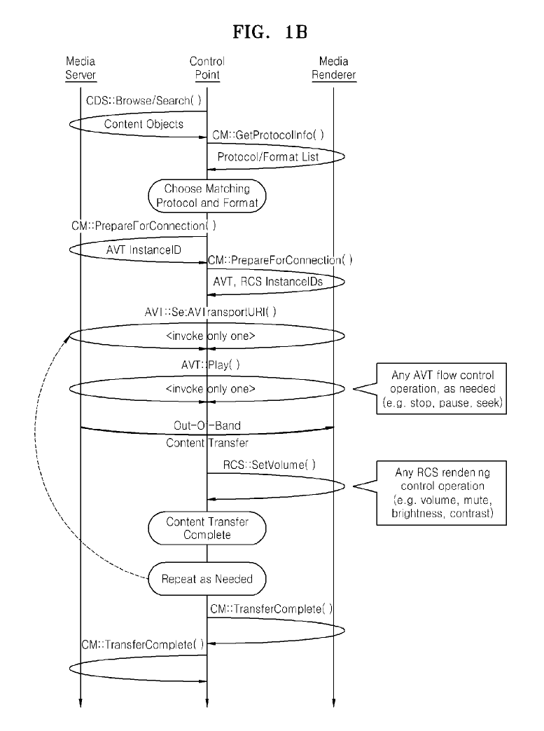

FIG. 3A is a flowchart illustrating a method of reproducing content using a UpnP device, according to an exemplary embodiment of the present invention;

FIG. 3B illustrates parameters used in an action “GetRenderingSurfaceInfo( )” according to an exemplary embodiment of the present invention;

FIG. 3C illustrates parameters used in an action “SetRenderingSurface( )” according to an exemplary embodiment of the present invention;

FIG. 4 is a flowchart illustrating a process of controlling a media renderer using a control point, according to an exemplary embodiment of the present invention;

FIG. 5 is a flowchart illustrating a process of reproducing content using a media renderer under the control of a control point, according to an exemplary embodiment of the present invention;

FIG. 6 illustrates the structures of a control point and a media renderer according to exemplary embodiments of the present invention; and

FIG. 7 illustrates an extensible markup language (XML) version of information regarding reproduction regions according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown. A process of controlling a media renderer using a control point in order to reproduce a content stream will hereinafter be described. However, it should be understood that the above process can be performed for each of a plurality of pieces of content and, thus, that a media renderer can simultaneously reproduce the pieces of content.

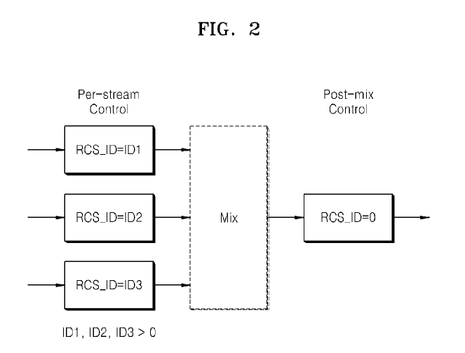

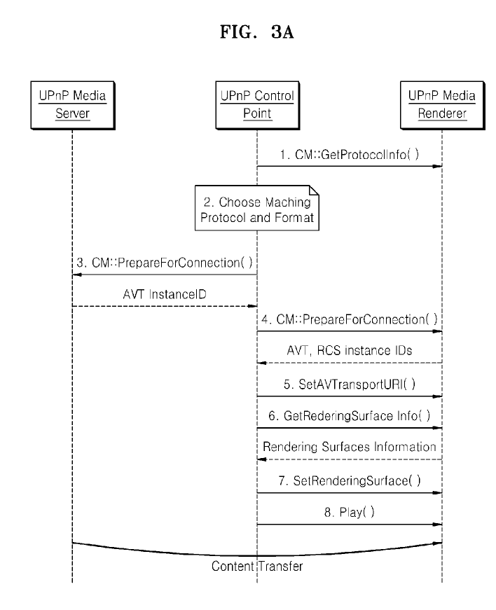

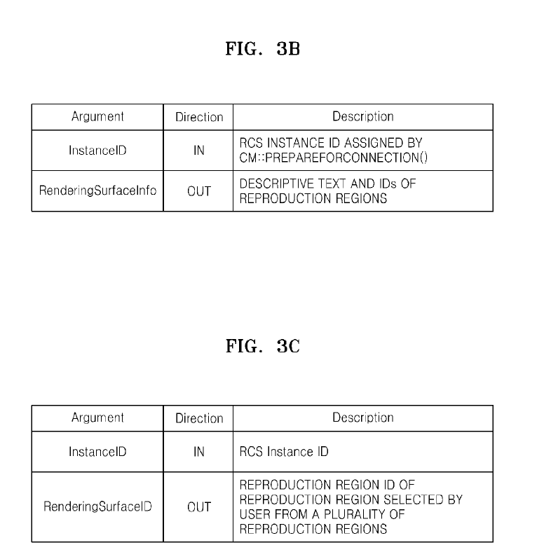

FIG. 3A is a flowchart illustrating a method of reproducing content using a media renderer, according to an exemplary embodiment of the present invention.

Referring to FIG. 3A, in processes 1 and 2, a control point obtains and designates protocol information that is to be used to transmit AV content. In addition, in processes 3 and 4, the control point calls an action “PrepareForConnection( )” provided by a ConnectionManager service and obtains instance information of an AV transport service (ATS) and that of an RCS. In order to simultaneously reproduce a plurality of pieces of content, the media renderer generates a virtual RCS instance ID as in the prior art and transmits the generated virtual RCS instance ID to the control point as an out parameter of the action “PrepareForConnection( ).”

In process 5, the control point calls an action “SetAVTransportURI( )” provided by the ATS and thus transmits URI information including real content data to the media renderer. The above processes are identical to those of the prior art.

When the media renderer provides a PIP function which simultaneously displays a main screen and an inset window, if the control point is dedicated to the media renderer, there would be no problem in selecting a reproduction region using a dedicated application. However, in the prior art, if the control point is not a dedicated control point, but a control point associated with a media server or a general universal plug and play (UPnP) control point, it cannot control the media renderer to reproduce a certain input stream on the main screen and a certain input stream on the inset window.

Hence, according to the current exemplary embodiment of the present invention, the control point first obtains information regarding reproduction regions from the media renderer and selects one of the reproduction regions. Then, the control point calls the action “PrepareForConnection( )”, obtains an RCS instance ID, and then calls an action “Play( ).” Accordingly, the control point controls the media renderer to reproduce a stream in the selected reproduction region when the action “Play( )” is called. These processes are processes 6 and 7.

In process 6, the control point requests the media renderer to provide information regarding a plurality of reproduction regions on a screen thereof This process may be a process of calling an action of the RCS provided by the media renderer. The action is newly defined in the present invention and will hereinafter be referred to as GetRenderingSurfaceInfo( ).

FIG. 3B illustrates parameters used in the action “GetRenderingSurfaceInfo( )” according to an exemplary embodiment of the present invention. That is, the control point calls the action “GetRenderingSurfaceInfo( )” of the media renderer and transmits an RCS instance ID to the media renderer, and the media renderer transmits information regarding reproduction regions as an output parameter to the control point. The information regarding the reproduction regions may include explanation text such as a “main screen” and an “inset window” which easily describe the reproduction regions for users, and a reproduction region ID of each reproduction region. The information regarding reproduction regions may be structured into an extensible markup language (XML) document.

In process 7, the control point informs the media renderer about a reproduction region selected for a piece of content from the reproduction regions. To this end, the present invention newly defines an action, which enables the control point to designate a reproduction region of the media renderer before calling the action “Play( ),” in the RCS. This action will hereinafter be referred to as SetRenderingSurface( ).

FIG. 3C illustrates parameters used in the action “SetRenderingSurface( )” according to an exemplary embodiment of the present invention;

That is, a reproduction region ID of a reproduction region selected by a user and an RCS instance ID for reproduction of corresponding content may be used as input parameters when the control point calls the action “SetRenderingSurface( ).” The media renderer receives, maps and stores the reproduction region ID and the RCS instance ID.

In process 8, when the control point calls the action “Play( ),” an AVTransport (AVT) instance ID is transmitted to the media renderer as an input parameter. Then, the media renderer searches for an RCS instance ID corresponding to the received AVT instance ID, searches for a reproduction region ID mapped to the found RCS instance ID, and reproduces content in a reproduction region indicated by the reproduction region ID.

The control point may call the action “Play( )” by omitting processes 6 and 7. In this case, the control point may control the media renderer to reproduce content in a predetermined default reproduction region.

As described above, according to the exemplary embodiment of the present invention, since the control point can designate a reproduction region for each piece of content, the media renderer can simultaneously reproduce a plurality of pieces of content in reproduction regions desired by a user.

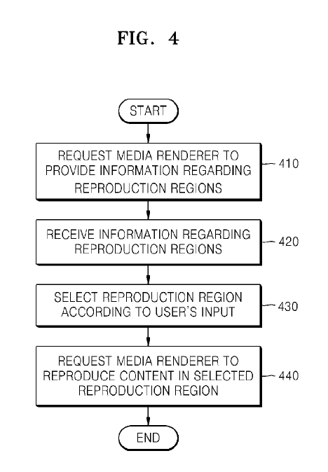

FIG. 4 is a flowchart illustrating a process of controlling a media renderer using a control point, according to an exemplary embodiment of the present invention. As described above, if the media renderer is a device which can divide its screen into a plurality of reproduction regions, the control point, which is dedicated to the media renderer and embedded in the device, can select one of the reproduction regions using a dedicated application. Therefore, it is assumed that the control point refers to a remote control point installed in a UPnP device which is separate from the media renderer.

In operation 410, the control point requests the media renderer to provide information regarding the reproduction regions on the screen. This operation may be a process of calling the action “GetRenderingSurfaceInfo( )” of the RCS provided by the media renderer.

In operation 420, the control point receives the information regarding the reproduction regions as an output parameter of the action “GetRenderingSurfaceInfo( ).”

In operation 430, if a user views descriptive text of the reproduction regions displayed on a user interface and selects one of the reproduction regions, the control point selects a reproduction region according to the user's input through the user interface.

In operation 440, the control point requests the media renderer to reproduce content in the selected reproduction region. As described above, the operation of requesting reproduction of the content using the control point is performed using the action “Play( )” defined in an ATS of the media renderer. The operation of designating a reproduction region of the media renderer before the control point calls the action “Play( )” is performed using the action “SetRenderingSurface( ).” When the action “SetRenderingSurface( )” is called, an RCS instance ID indicating reproduction of the content and a reproduction region ID of the reproduction region selected by the user are transmitted to the media renderer as arguments.

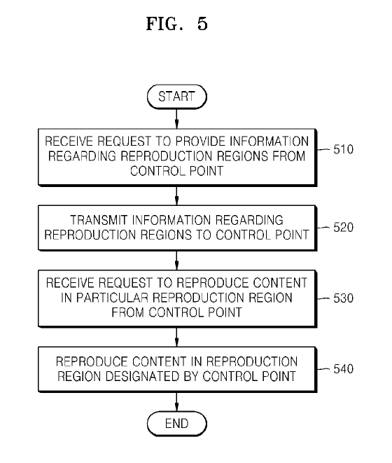

FIG. 5 is a flowchart illustrating a process of reproducing content using a media renderer, according to an exemplary embodiment of the present invention.

Referring to FIG. 5, in operation 510, the media renderer is requested by a control point to provide information regarding reproduction regions. In this operation, the media renderer receives a message for calling the action “GetRenderingSurfaceInfo( ).”

In operation 520, the media renderer transmits the information regarding the reproduction regions to the control point. The information regarding the reproduction regions may be an XML document which includes descriptive text of the reproduction regions and a reproduction region ID of each reproduction region.

In operation 530, the media renderer is requested by the control point to reproduce content in a selected reproduction region. In this operation, the control point calls the action “SetRenderingSurface( )” of the RCS and the action “Play( )” of the AVT. A message for calling the action “SetRenderingSurface( )” includes, as arguments, an RCS instance ID indicating reproduction of corresponding content and a reproduction region ID of a reproduction region selected by a user. If the action “Play( )” is called, a corresponding RCS instance ID and a corresponding reproduction region ID are searched for using an AVT instance ID received as an argument.

In operation 540, the media renderer reproduces content, which corresponds to the RCS instance ID, in a reproduction region indicated by the reproduction region ID.

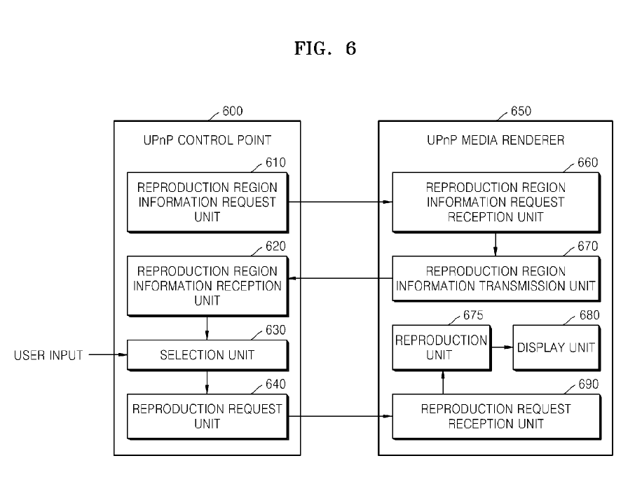

FIG. 6 illustrates the structures of a control point 600 and a media renderer 650 according to exemplary embodiments of the present invention.

Referring to FIG. 6, the control point 600 according to the current exemplary embodiment of the present invention includes a reproduction region information request unit 610, a reproduction region information reception unit 620, a selection unit 630, and a reproduction request unit 640.

The reproduction region information request unit 610 calls the action “GetRenderingSurfaceInfo( )” defined in the RCS of the media renderer 650 and thus requests information regarding reproduction regions. The reproduction region information reception unit 620 receives the information regarding the reproduction regions in response to the call for the action “GetRenderingSurfaceInfo( ).”

The selection unit 630 selects one of the reproduction regions according to a user's input. In order to select a reproduction region, the user may refer to descriptive text which is written in a way that can be easily recognized by users and which is included in the information regarding the reproduction regions.

The reproduction request unit 640 requests the media renderer 650 to reproduce content in a reproduction region selected by the selection unit 630. That is, the reproduction request unit 640 designates a reproduction region by calling the action “SetRenderingSurface( )” of the RCS and then calls the action “Play( )” of the AVT.

The media renderer 650 according to the current exemplary embodiment of the present invention includes a reproduction region information request reception unit 660, a reproduction region information transmission unit 670, a reproduction unit 675, a display unit 680, and a reproduction request reception unit 690.

The reproduction region information request reception unit 660 receives a message for calling the action “GetRenderingSurfaceInfo( )” from the control point 600. In so doing, the reproduction region information request reception unit 660 is requested to provide information regarding reproduction regions.

The reproduction region information transmission unit 670 transmits the information regarding the reproduction regions to the control point 600 in response to the call for the action “GetRenderingSurfaceInfo( ).”

The reproduction request reception unit 690 is informed by the control point 600 about a designated reproduction region and is requested to reproduce content in the designated reproduction region. That is, after receiving an RCS instance ID and a reproduction region ID through a message for calling the action “SetRenderingSurface( ),” the reproduction request reception unit 690 maps and manages the RCS instance ID and the reproduction region ID. Next, after receiving an AVT instance ID through a message for calling the action “Play( ),” the reproduction request reception unit 690 searches for an RCS instance ID corresponding to an AVT instance ID and searches for a reproduction region ID mapped to the RCS instance ID.

The reproduction unit 675 reproduces content in a reproduction region selected by the control point 600 from the reproduction regions, that is, a reproduction region corresponding to a reproduction region ID sent by the control point 600.

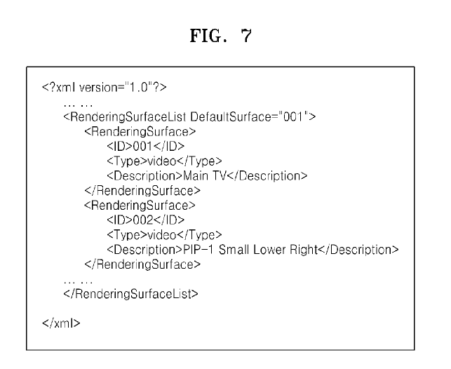

FIG. 7 illustrates an XML version of information regarding reproduction regions, according to an exemplary embodiment of the present invention.

Referring to FIG. 7, the information regarding the reproduction regions according to the current exemplary embodiment of the present invention includes reproduction region IDs and descriptive text of each reproduction region. In the present exemplary embodiment, the descriptive text of a reproduction region, which corresponds to a reproduction region ID of 001, indicates “Main TV,” and that of a reproduction region, which corresponds to a reproduction region ID of 002, indicates “PIP-1 Small Lower Right.” The descriptive text is displayed on a user interface for a user. Therefore, the user can set a reproduction region with reference to the descriptive text.

According to the exemplary embodiments of the present invention, a control point can designate a reproduction region for each of a plurality of pieces of content that is to be reproduced by a media renderer. Therefore, a user can simultaneously enjoy a plurality of pieces of content in desired reproduction regions of a single UPnP device screen.

The exemplary embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.) and optical recording media (e.g., CD-ROMs, or DVDs).

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of controlling a universal plug and play (UPnP) device which has a plurality of reproduction regions on a screen thereof, at a remote control point, the method comprising:
receiving information regarding the reproduction regions from the UPnP device;
selecting one of the reproduction regions according to an input; and
requesting the UPnP device to reproduce content in the reproduction region which is selected.

2. The method of claim 1, further comprising requesting information regarding the reproduction regions by calling an action of a rendering control service (RCS) provided by a media renderer of the UPnP device.

3. The method of claim 1, wherein the information regarding the reproduction regions comprises an extensible markup language (XML) document which comprises descriptive text of the reproduction regions and respective reproduction region identifiers (IDs) of the reproduction regions.

4. The method of claim 2, wherein the requesting comprises transmitting a message informing the media renderer of the UPnP device about the reproduction region, wherein the message is used to call the action of the RCS provided by the media renderer of the UPnP device, and the message comprises a reproduction region ID of the reproduction region and an RCS instance ID for reproduction of the content.

5. A computer readable recording medium having recorded thereon a computer program for executing the method of claim 1.

6. A control point remotely controlling a universal plug and play (UPnP) device which has a plurality of reproduction regions on a screen thereof, the control point comprising:
a reproduction region information reception unit which receives information regarding the reproduction regions from the UPnP device;
a selection unit which selects one of the reproduction regions according to an input; and
a reproduction request unit which requests the UPnP device to reproduce content in the reproduction region which is selected by the selection unit.

7. The control point of claim 6, further comprising a reproduction region information request unit which requests information regarding the reproduction regions by calling an action of a rendering control service (RCS) provided by a media renderer of the UPnP device.

8. The control point of claim 6, wherein the information regarding the reproduction regions comprises an extensible markup language (XML) document which comprises descriptive text of the reproduction regions and respective reproduction region identifiers (IDs) of the reproduction regions.

9. The control point of claim 7, wherein the reproduction region information request unit transmits a message informing the media renderer of the UPnP device about the reproduction region to the UPnP device, wherein the message is used to call the action of the RCS provided by the media renderer of the UPnP device and the message comprises a reproduction region ID of the selected reproduction region and an RCS instance ID for reproduction of the content.

10. A method of reproducing content at a universal plug and play (UPnP) device which has a plurality of reproduction regions on a screen thereof, the method comprising:
transmitting information regarding the reproduction regions to a remote control point;
receiving, from the control point, a request to reproduce content in a reproduction unit of the reproduction regions designated by the control point; and
reproducing the content in the reproduction region designated by the control point.

11. The method of claim 10, further comprising receiving a message requesting the information regarding the reproduction regions from the control point, wherein the message is used to call an action of a rendering control service (RCS) provided by a media renderer of the UPnP device.

12. The method of claim 10, wherein the information regarding the reproduction regions comprises an extensible markup language (XML) document which comprises descriptive text of the reproduction regions and respective reproduction region identifiers (IDs) of the reproduction regions.

13. The method of claim 12, wherein the receiving the request comprises receiving, from the control point, a message for calling the action of the RCS provided by the media renderer of the UPnP device, wherein the message comprises a reproduction region ID of the designated reproduction region and an RCS instance ID for reproduction of the content.

14. A computer readable recording medium having recorded thereon a computer program for executing the method of claim 10.

15. A universal plug and play (UPnP) device having a plurality of reproduction regions on a screen thereof, the device comprising:
a reproduction region information transmission unit which transmits information regarding the reproduction regions to a remote control point;
a reproduction request reception unit which receives, from the control point, a request to reproduce content in a reproduction region of the reproduction regions designated by the control point; and
a content reproduction unit reproducing the content in a reproduction region designated by the control point.

16. The device of claim 15, further comprising a reproduction region request reception unit which receives a message requesting the information regarding the reproduction regions from the control point, wherein the message is used to call an action of an RCS provided by a media renderer of the UPnP device.

17. The device of claim 15, wherein the information regarding the reproduction regions comprises an extensible markup language (XML) document which comprises descriptive text of the reproduction regions and respective reproduction region IDs of the reproduction regions.

18. The device of claim 17, wherein the reproduction request reception unit receives, from the control point, a message for calling the action of the RCS provided by the media renderer of the UPnP device, wherein the message comprises a reproduction region ID of the reproduction region and an RCS instance ID for reproduction of the content.
